(19) United States
(12) Patent Application Publication
(10) Pub. No.: US 2010/0151287 A1
(43) Pub. Date: Jun. 17, 2010

(54) ADAPTIVE ANODE BLEED STRATEGY

(75) Inventor: Akbar Chowdhury, Pittsford, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC, Detroit, MI (US)

(21) Appl. No.: 12/336,144

(22) Filed: Dec. 16, 2008

(51) Int. Cl. H01M 8/04; H01M 2/12

(52) U.S. Cl. 429/13; 429/25

(57) ABSTRACT

A system for providing an adaptive anode bleed strategy for bleeding nitrogen from the anode side of a fuel cell stack. The system includes a hydrogen concentration sensor provided in an exhaust line from the fuel cell stack that provides a hydrogen concentration reading of the hydrogen being emitted from the stack during the bleed. A controller analyzes the hydrogen concentration reading during the bleed and determines when a plateau in the hydrogen concentration begins to spike upward, indicating that more hydrogen is being emitted and less nitrogen is being emitted. By looking at multiple hydrogen concentration plateaus over multiple bleeds, the controller can calculate an efficient bleed duration for the bleed event for different current densities of the fuel cell stack, where the bleed can be stopped just after the hydrogen concentration spike occurs. Thus, the duration of the bleed is adapted over the life of the stack.

### BACKGROUND OF THE INVENTION

1. Field of the Invention

This invention relates generally to a system and method for providing an anode exhaust gas bleed to remove nitrogen from the anode side of a fuel cell stack and, more particularly, to a system and method for providing an anode exhaust gas bleed to remove nitrogen from the anode side of a fuel cell stack that is adaptive over the life of the stack by changing the bleed duration, where the bleed duration is determined based on the concentration of hydrogen being emitted from the stack.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The MEAs are permeable and thus allow nitrogen in the air from the cathode side of the stack to permeate therethrough and collect in the anode side of the stack, referred to in the industry as nitrogen cross-over. Even though the anode side pressure may be higher than the cathode side pressure, the cathode side partial pressures will cause air to permeate through the membrane. Nitrogen in the anode side of the fuel cell stack dilutes the hydrogen such that if the nitrogen concentration increases beyond a certain percentage, such as 50%, the fuel cell stack becomes unstable and may fail. It is known in the art to provide a bleed valve at the anode exhaust gas output of the fuel cell stack to remove nitrogen from the anode side of the stack.

An algorithm may be employed to provide an online estimation of the nitrogen concentration in the anode exhaust gas during stack operation to know when to trigger the anode exhaust gas bleed. The algorithm may track the nitrogen concentration over time in the anode side of the stack based on the permeation rate from the cathode side to the anode side, and the periodic bleeds of the anode exhaust gas. When the algorithm calculates an increase in the nitrogen concentration above a predetermined threshold, for example 10%, it may trigger the bleed. The bleed is typically performed for a duration that allows multiple stack anode volumes to be bled, thus reducing the nitrogen concentration below the threshold.

Some fuel cell systems employ anode flow shifting where the fuel cell stack is split into sub-stacks and the anode reactant gas is flowed through the split sub-stacks in alternating directions. In these types of designs, a bleed manifold unit (BMU) is sometimes provided between the split sub-stacks that includes the valves for providing the anode exhaust gas bleed.

One known anode exhaust gas bleed control algorithm determines the duration of the bleed based on a fixed time that would eliminate the desired amount of nitrogen. However, as a fuel cell stack ages, the fuel cells in the stack degrades where nitrogen bleeds would be required more often as cell performance decreases. Therefore, those systems that employ a fixed bleed duration typically select a bleed duration for the mid-life of the stack as a suitable average for the entire stack life. However, such an anode bleed strategy is obviously not efficient for the whole life of stack where the bleed duration typically would be too long when the stack is new and too short when the stack is near the end of its life. When the bleed is too long, the system operates inefficiently because a significant amount of hydrogen is being exhausted out of the anode exhaust. When the bleed is too short, the fuel cells begin to collapse, which triggers an anode bleed that normally may not be necessary. Typically, the bleed duration and bleed frequency is determined for different current density ranges of the stack, but which are fixed values through the life of the stack.

### SUMMARY OF THE INVENTION

In accordance with the teachings of the present invention, a system and method are disclosed for providing an adaptive anode bleed strategy for bleeding nitrogen from the anode side of a fuel cell stack. The system includes a hydrogen concentration sensor provided in an exhaust line from the fuel cell stack that provides a hydrogen concentration reading of the hydrogen being emitted from the stack during the bleed. A controller analyzes the hydrogen concentration reading during the bleed and determines when a plateau in the hydrogen concentration begins to spike upward, indicating that more hydrogen is being emitted and less nitrogen is being emitted. By looking at multiple hydrogen concentration plateaus over multiple bleeds, the controller can calculate an efficient bleed duration for the bleed event for different current densities of the fuel cell stack, where the bleed can be stopped just after the hydrogen concentration spike occurs. Thus, the duration of the bleed is adapted over the life of the stack.

Additional features of the present invention will become apparent from the following description and appended claims, taken in conjunction with the accompanying drawings.

### BRIEF DESCRIPTION OF THE DRAWINGS

FIG. 1 is a block diagram of a fuel cell system including components for performing an adaptive anode bleed strategy;

FIG. 2 is a graph with time on the horizontal axis and hydrogen concentration on the vertical axis showing a hydrogen concentration level during an anode bleed; and

FIG. 3 is a graph with time on the horizontal axis and magnitude on the vertical axis showing an anode bleed duration.

### DETAILED DESCRIPTION OF THE EMBODIMENTS

The following discussion of the embodiments of the invention directed to a system and method for providing an adaptive anode bleed strategy that changes the duration of the anode bleed over the life of a fuel cell stack is merely exemplary in nature, and is in no way intended to limit the invention or its applications or uses.

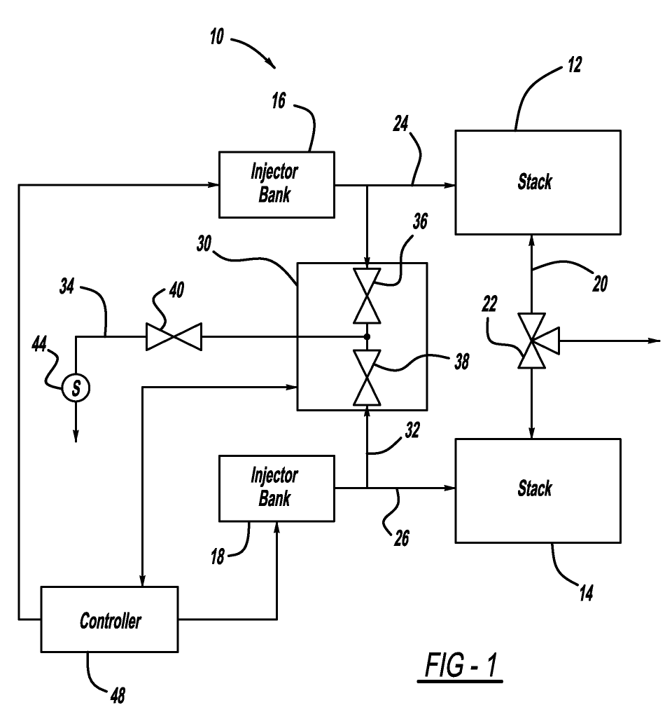

FIG. 1 is a block diagram of a fuel cell system 10 including split fuel cell sub-stacks 12 and 14 that operate under anode flow shifting. When the flow is in one direction, an injector bank 16 injects fresh hydrogen into the anode side of the sub-stack 12 on anode input line 24. Anode gas that is output from the sub-stack 12 is sent to the sub-stack 14 on connecting line 20. When the flow is in the opposite direction, an injector bank 18 injects fresh hydrogen into the anode side of the sub-stack 14 on anode input line 26 that is output from the sub-stack 14 and sent to the sub-stack 12 on the line 20. A drain valve 22 is provided in the line 20 and can be used for a center bleed.

A BMU 30 is provided at an anode input to the split sub-stacks 12 and 14 and provides an anode exhaust gas bleed during certain times to remove nitrogen from the anode side of the sub-stacks 12 and 14 based on any suitable bleed schedule. The BMU 30 includes a line 32 that connects the anode input lines 24 and 26 and an exhaust line 34 for the system 10. Although not specifically shown for clarity, the cathode exhaust from the sub-stacks 12 and 14 is mixed with the anode exhaust from the sub-stacks 12 and 14 in the exhaust line 34. A first bleed valve 36 is provided in the line 32 proximate to the sub-stack 12 and a second bleed valve 38 is provided in the line 32 proximate the sub-stack 14.

An exhaust valve 40 is provided in the line 34 that controls the system exhaust flow. A hydrogen concentration sensor 44 is provided in the line 34 downstream from the valve 40 and measures the concentration of hydrogen in the mixed cathode and anode exhaust in the line 34 being output from the system 10. A controller 48 controls the injector banks 16 and 18 and the valves 36, 38 and 40, and receives the hydrogen concentration measurement from the sensor 44.

In the known fuel cell system, the hydrogen concentration sensor 44 is typically employed as a safety device so that the concentration of hydrogen being emitted to the environment is maintained below a certain percentage, such as 4%. The anode bleed algorithms currently employed in the art are provided so that the mixture of hydrogen with cathode exhaust maintains a concentration well below this value. However, failures and other system operations could produce an event that emitted more hydrogen into the environment, possibly combustible, where the bleed valves 36 and 38 would be closed to prevent such an occurrence.

When the system 10 is operating under anode flow-shifting and no bleed is commanded, the bleed valves 36 and 38 are both closed, so that depending on the direction of the anode gas flow, the output of the second sub-stack is dead-ended. If a bleed is commanded, and the flow-shifting is in the direction from the sub-stack 12 to the sub-stack 14 through the line 20, then the bleed valve 38 is opened and the bleed valve 36 is closed. Likewise, if a bleed is commanded and the flow is in the direction from the sub-stack 14 to the sub-stack 12 through the line 20, then the first bleed valve 36 is opened and the second bleed valve 38 is closed. Thus, the anode exhaust gas is bled out of the exhaust line 34 through the exhaust valve 40.

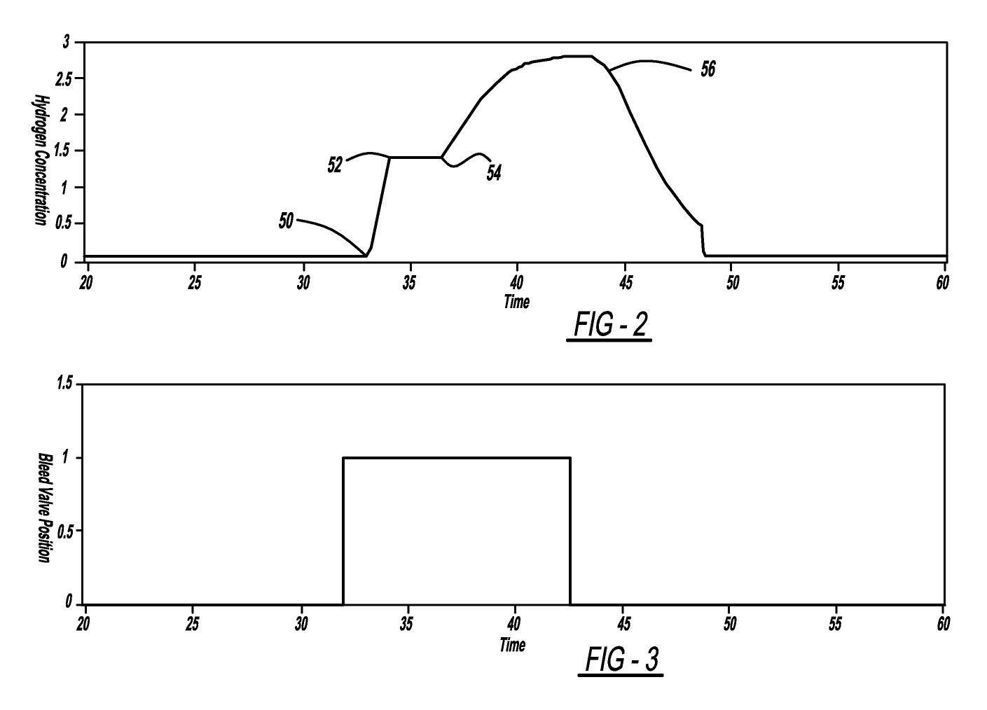

FIG. 2 is a graph with time on the horizontal axis and hydrogen concentration on the vertical axis showing a typical hydrogen concentration profile over a typical bleed duration. FIG. 3 is a graph with time on the horizontal axis and bleed valve position on the vertical axis showing a typical bleed duration of about 10 seconds when one or the other of the bleed valves 36 or 38 is open to provide the anode bleed, as discussed above. During this bleed, the hydrogen concentration sensor 44 measures the concentration of hydrogen being emitted from the anode exhaust gas line 34. After the bleed valve 36 or 38 is opened, the hydrogen concentration begins to rise at location 50 and then plateaus at location 52 for a number of seconds where the hydrogen concentration remains substantially constant. During locations 50 and 52, the concentration of nitrogen being emitted in the line 34 is relatively high and the concentration of hydrogen being emitted is relatively low. At some period during the bleed event, the concentration of hydrogen will begin to rise from the plateau 52 at rise location 54 where the concentration of hydrogen increases to some maximum level where the concentration of hydrogen is relatively high and the concentration of nitrogen is relatively low. After the bleed valves 36 and 38 are closed, the concentration of hydrogen then declines at location 56 towards zero. This general shape of the hydrogen concentration during the anode bleed occurs at nearly every bleed event regardless of stack current density.

The present invention recognizes that the bleed duration as described above is too long where the bleed is operating inefficiently because a significant amount of hydrogen is being emitted from the anode exhaust during the end of the bleed. The present invention proposes reducing the anode bleed time based on the concentration of hydrogen that is being emitted from the anode exhaust gas line. In this regard, an algorithm is provided that monitors the concentration of hydrogen from the concentration sensor 44 and identifies the plateau 52 and the rise location 54 where the concentration of hydrogen begins to increase significantly from the plateau 52. The algorithm then determines the bleed duration based on a time where the bleed valves 36 and 38 will be closed just after the rise location 56.

In one non-limiting embodiment, the algorithm determines the duration of the bleed by exceeding the bleed duration past the rise location 56 by about 10% of the total bleed duration. Therefore, the bleed duration is assured to be past the rise location 56 where the concentration of hydrogen is increasing and the concentration of nitrogen is decreasing.

As the sub-stacks 12 and 14 age, the length of the plateau 52 will increase. The algorithm will monitor that increase by determining when the rise location 56 occurs so that the bleed duration can be increased accordingly. The anode bleed strategy is thus adaptive in that as the stack ages and the plateau duration increases, the bleed duration will also increase based on the determination of the end of the plateau 52, as discussed herein. Therefore, towards the end of the stack life when the known systems would have more frequent bleeds as a result of the bleed duration being too short, the present anode bleed strategy would overcome those increases in the frequency of the bleed events by knowing when the plateau 52 ended and the bleed event should end. Thus, even though the bleed event may increase in duration towards the end of life of the stack, the bleed event frequency may not increase.

The algorithm can be provided so that it is suitable for the real life operation of the system. For example, each bleed event may not provide the specific profile shown in FIG. 2 for one reason or another, and may not include the plateau 52. Therefore, those data measurements for those bleed events cannot be used for determining bleed duration. The actual time of the plateau 52 may vary from bleed event to bleed event, where the algorithm may take an average plateau duration for a number of bleed events before calculating the desired duration of the bleed event. The algorithm thus may maintain a rolling average of plateau durations that can be used to populate a table for different stack current densities, which can be used to determine the bleed duration.

For the split stack configuration of the system 10, the algorithm may employ two separate bleed event durations for the two separate bleed valves 36 and 38 that may be different as a result of the sub-stacks 12 and 14 aging differently or having different performing cells.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
at least one fuel cell stack;
at least one anode bleed valve coupled to an anode output of the at least one fuel cell stack and being operable to provide an anode exhaust gas bleed from the anode side of the fuel cell stack;
a hydrogen concentration sensor positioned to measure the concentration of hydrogen being output from the at least one fuel cell stack; and
a controller responsive to a hydrogen concentration signal from the hydrogen concentration sensor, said controller controlling the at least one bleed valve to open and close the bleed valve to provide a desired bleed duration for bleeding nitrogen from the at least one fuel cell stack, said controller determining a region from the hydrogen concentration signal where the concentration of hydrogen is substantially constant and determining when the hydrogen concentration increases from being substantially constant where the duration of the anode bleed is determined based on when the hydrogen concentration increases from the constant hydrogen concentration level.

2. The system according to claim 1 wherein the controller determines that the bleed will stop after the increase in the concentration of hydrogen from the constant hydrogen concentration level at a time that is about 10% of the duration of the entire anode bleed.

3. The system according to claim 1 wherein the controller determines the duration of the anode bleed based on an average of durations of constant hydrogen concentration levels over multiple anode bleeds.

4. The system according to claim 1 wherein the controller determines the duration of the anode bleed based on the length of the constant hydrogen concentration level for multiple current densities of the at least one fuel cell stack.

5. The system according to claim 1 wherein the at least one fuel cell stack is split sub-stacks and the at least one anode bleed valve is a separate anode bleed valve for each split sub-stack, wherein the controller determines the anode bleed duration for both of the anode bleed valves using the hydrogen concentration signal.

6. The system according to claim 5 wherein the anode bleed valves are part of a bleed manifold unit.

7. The system according to claim 1 wherein the hydrogen concentration sensor is positioned in a system exhaust line that outputs a mixed cathode and anode exhaust.

8. The system according to claim 1 wherein the controller increases the duration of the anode bleed as the at least one fuel cell stack ages.

9. A fuel cell system comprising:
a first split sub-stack;
a second split sub-stack;
a bleed manifold unit including a first anode bleed valve positioned proximate an anode input of the first split sub-stack and a second anode bleed valve positioned proximate to an anode input of the second split sub-stack, said first and second split sub-stacks operating under anode flow shifting;
a hydrogen concentration sensor positioned to measure the concentration of hydrogen being output from the first and second split sub-stacks, said hydrogen concentration sensor providing a hydrogen concentration signal; and
a controller for controlling the first and second bleed valves for an anode bleed during the flow shifting operation of the first and second split sub-stacks so that when the flow is from the first split sub-stack to the second split sub-stack, the second bleed valve is open and when the flow is from the second split sub-stack to the first split sub-stack, the first bleed valve is open, said controller further controlling the first and second bleed valves to provide an adaptive bleed duration, said controller determining a region from the hydrogen concentration signal where the concentration of hydrogen is substantially constant and determining when the hydrogen concentration increases from being substantially constant where the duration of the anode bleed is determined based on when the hydrogen concentration increases from the constant hydrogen concentration.

10. The system according to claim 9 wherein the hydrogen concentration sensor is positioned in a system exhaust line that outputs a mixed cathode and anode exhaust.

11. The system according to claim 9 wherein the controller determines that the bleed will stop after the increase in the concentration of hydrogen from the constant hydrogen concentration is for a time that is about 10% of the duration of the entire anode bleed.

12. The system according to claim 9 wherein the controller determines the duration of the anode bleed based on an average of durations of constant hydrogen concentration levels over multiple anode bleeds.

13. The system according to claim 9 wherein the controller determines the duration of the anode bleed based on the length of the constant hydrogen concentration level for multiple current densities of the least one fuel cell stack.

14. The system according to claim 9 wherein the controller increases the duration of the anode bleed as the at least one fuel cell stack ages.

15. A method for providing an anode bleed from an anode side of a fuel cell stack, said method comprising:
determining the concentration of hydrogen in an exhaust gas line during the nitrogen bleed;
identifying a plateau in the hydrogen concentration where the concentration of hydrogen is substantially constant; and
stopping the anode bleed a certain time after the plateau ends and the hydrogen concentration increases.

16. The method according to claim 15 wherein stopping the anode bleed a certain period of time after the plateau includes stopping the anode bleed after the plateau ends based on a time frame of about 10% of a total anode bleed duration.

17. The method according to claim 15 wherein stopping the anode bleed includes stopping the anode bleed based on an average of plateau lengths from multiple anode bleeds.

18. The method according to claim 15 wherein stopping the anode bleed include stopping the anode bleed a certain time after the plateau ends for different stack current densities.

19. The method according to claim 15 wherein the duration of the anode bleed increases as the fuel cell stack ages.

20. The method according to claim 15 wherein the fuel cell stack is split sub-stacks.
